(19) United States
(12) Patent Application Publication
(10) Pub. No.: US 2024/0272699 A1
(43) Pub. Date: Aug. 15, 2024

(54) POWER MANAGEMENT

(71) Applicant: Arm Limited, Cambridge (GB)

(72) Inventors: Souvik Kumar Chakravarty, Cambridge (GB); Angus William James Logan, Cambridge (GB); Dominic William Brown, Ely (GB)

(73) Assignee: Arm Limited, Cambridge (GB)

(21) Appl. No.: 18/430,932

(22) Filed: Feb. 2, 2024

(30) Foreign Application Priority Data
Feb. 13, 2023 (GB) 2301989.6

(51) Int. Cl. G06F 1/324; G06F 1/3296

(52) U.S. Cl. CPC G06F 1/324; G06F 1/3296

(57) ABSTRACT

An apparatus, method and computer program are described. The apparatus comprises throttling control circuitry (215), associated with a given processing element (205), to perform a throttling-level selection process to select a throttling level indicative of an execution rate at which higher-power processing tasks received by the given processing element are to be issued to processing circuitry of the given processing element. The apparatus also comprises power management circuitry (220) to perform a power control process to select an operating voltage and/or clock frequency to be used by the given processing element, wherein the power management circuitry is configured to select the operating voltage and/or clock frequency in dependence on the throttling level selected for the given processing element, and at least one register (225) accessible to firmware. The apparatus is configured to control the selection of at least one energy control parameter in dependence on a value read from the at least one register.

The present disclosure relates to power management. For instance, the present techniques could be used in relation to power management of a data processing apparatus.

A data processing apparatus might not have the capability to provide sufficient power for the entire device to run at full capacity. In particular, high energy events (HEEs, also referred to herein as “high power events” (HPEs) or “higher-power processing tasks”) might cause auxiliary circuits to be activated, which consume large amounts of power. When such events are unregulated and when the processor circuits simultaneously request higher voltages and frequencies, the provided power supply might not be able to respond. This can also be exacerbated by thermal factors.

To address this issue, power management mechanisms may be provided to detect and limit high energy events. Such mechanisms are controlled by firmware, which may determine whether the count of high energy events exceeds a pre-defined threshold, and in response may temporarily limit execution of (e.g. throttle) certain types of instructions (e.g. by delaying the execution of some instructions). The firmware may also provide information that allows a power controller to switch to a different Dynamic Voltage and Frequency Scaling (DVFS) operating point (e.g. to a different voltage/frequency).

Viewed from a first example of the present technique, there is provided an apparatus comprising:
throttling control circuitry associated with a given processing element, the throttling control circuitry being configured to perform a throttling-level selection process to select a throttling level indicative of an execution rate at which higher-power processing tasks received by the given processing element are to be issued to processing circuitry of the given processing element;
power management circuitry to perform a power control process to select an operating voltage and/or clock frequency to be used by the given processing element, wherein the power management circuitry is configured to select the operating voltage and/or clock frequency in dependence on the throttling level selected for the given processing element; and
at least one register accessible to firmware,
wherein the apparatus is configured to control the selection of at least one energy control parameter in dependence on a value read from the at least one register.

Viewed from another example of the present technique, there is provided a method comprising:
performing a throttling-level selection process to select a throttling level for a given processing element, the throttling level for the given processing element being indicative of an execution rate at which higher-power processing tasks received by the given processing element are to be issued to processing circuitry of the given processing element;
performing a power control process to select an operating voltage and/or clock frequency to be used by the given processing element, wherein the operating voltage and/or clock frequency is selected in dependence on the throttling level selected for the given processing element; and
controlling the selection of at least one energy control parameter in dependence on a value read from at least one register, the at least one register being accessible to firmware.

Viewed from another example of the present technique, there is provided a computer program comprising computer-readable code which, when executed on a computer, causes the computer to fabricate an apparatus comprising:
throttling control circuitry associated with a given processing element, the throttling control circuitry being configured to perform a throttling-level selection process to select a throttling level indicative of an execution rate at which higher-power processing tasks received by the given processing element are to be issued to processing circuitry of the given processing element;
power management circuitry to perform a power control process to select an operating voltage and/or clock frequency to be used by the given processing element, wherein the power management circuitry is configured to select the operating voltage and/or clock frequency in dependence on the throttling level selected for the given processing element; and
at least one register accessible to firmware,
wherein the apparatus is configured to control the selection of at least one energy control parameter in dependence on a value read from the at least one register.

Viewed from another example of the present technique, there is provided a computer-readable medium to store the computer program described above. The computer-readable medium may be a transitory computer-readable medium or a non-transitory computer-readable medium.

Further aspects, features and advantages of the present technique will be apparent from the following description of examples, which is to be read in conjunction with the accompanying drawings, in which:

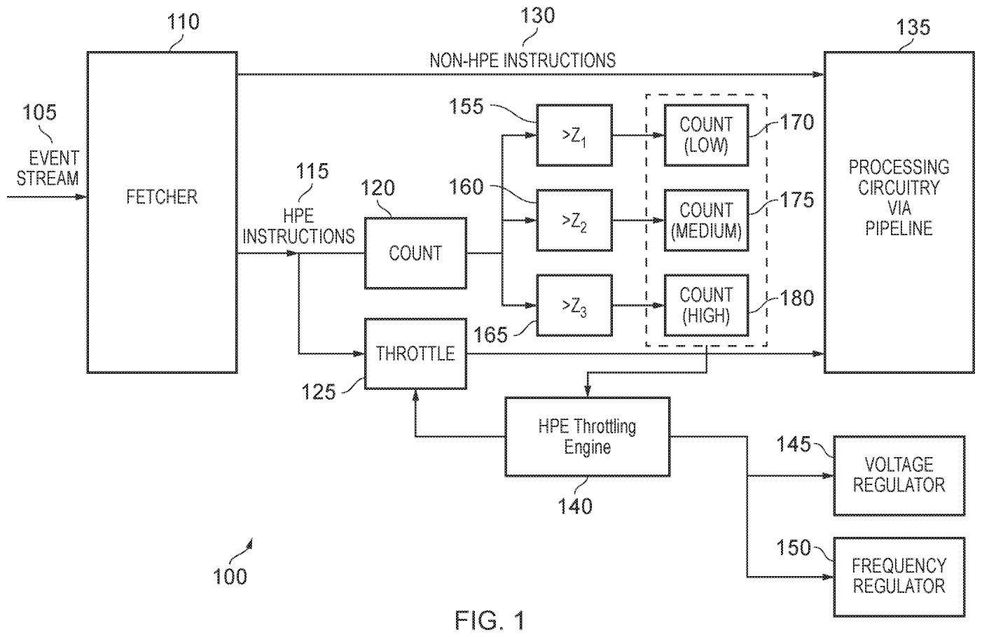

FIG. 1 shows an example of a data processing apparatus;

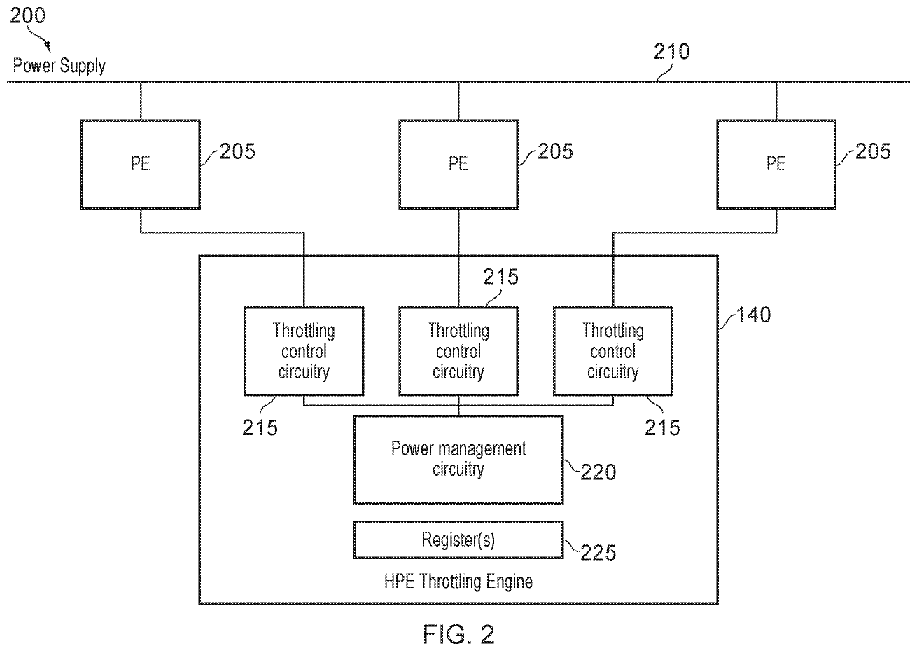

FIG. 2 shows another example of a data processing apparatus, this example comprising multiple processor cores and an HPE throttling engine;

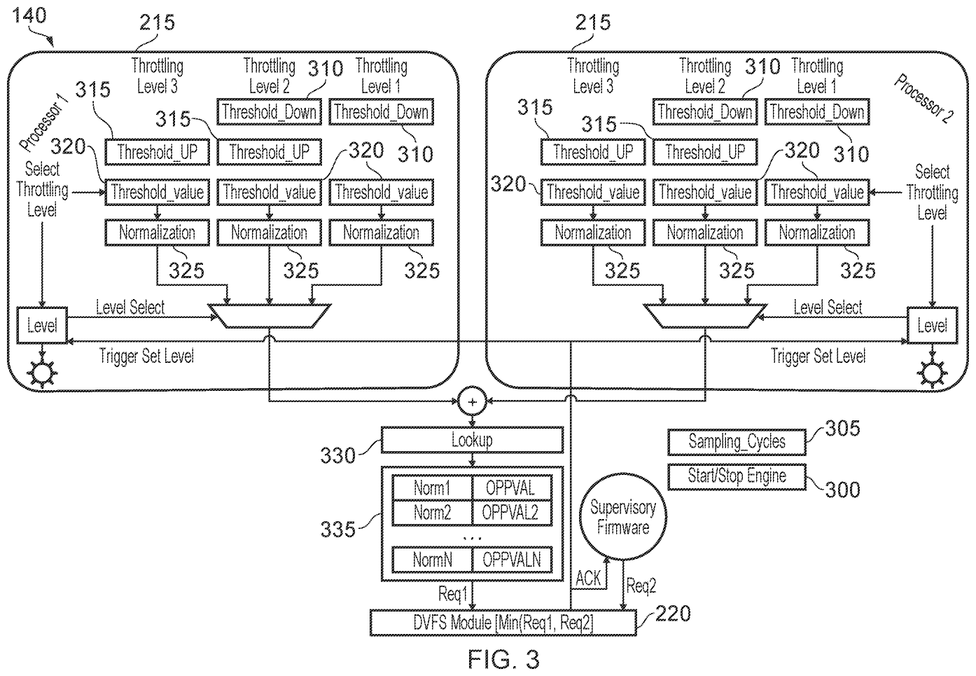

FIG. 3 shows an example of an HPE throttling engine;

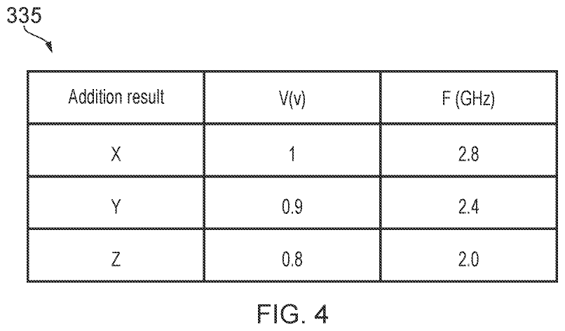

FIG. 4 shows a voltage/frequency lookup table;

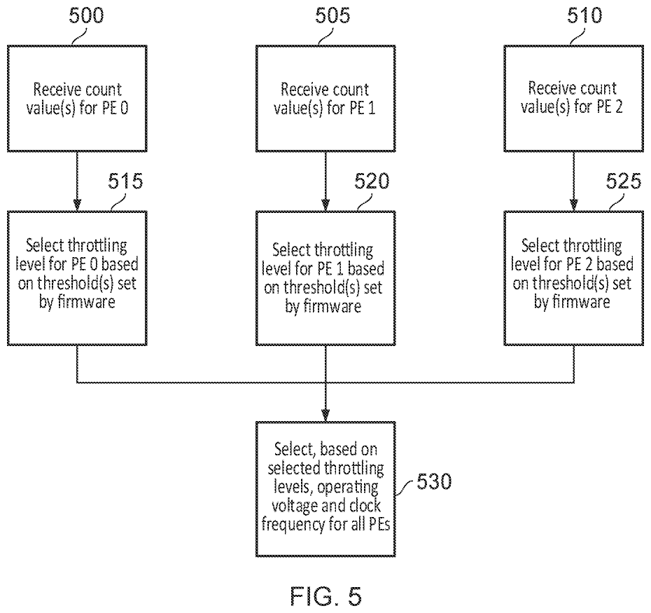

FIG. 5 is a flow diagram showing a method of controlling HPE throttling and voltage and/or clock frequency for a multi-core data processing apparatus; and

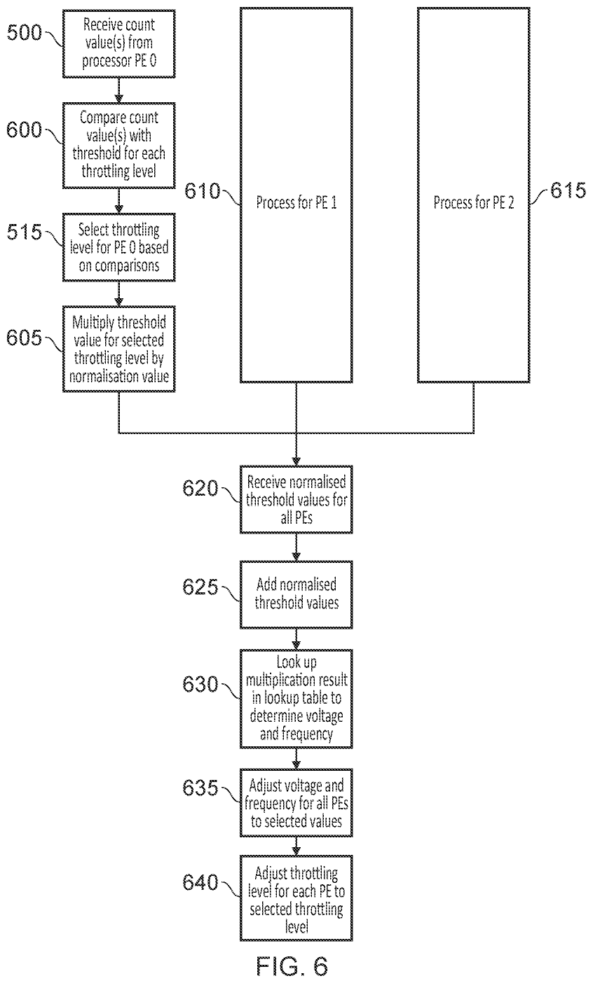

FIG. 6 is a more detailed example of the method of FIG. 5.

Before discussing example implementations with reference to the accompanying figures, the following description of example implementations and associated advantages is provided.

In accordance with one example configuration there is provided an apparatus comprising throttling control circuitry associated with a given processing element. The throttling control circuitry is configured to perform a throttling-level selection process to select a throttling level indicative of an execution rate at which higher-power processing tasks received by the given processing element are to be issued to processing circuitry of the given processing element. In addition, the apparatus comprises power management circuitry to perform a power control process to select an operating voltage and/or clock frequency to be used by the given processing element, wherein the power management circuitry is configured to select the operating voltage and/or clock frequency in dependence on the throttling level selected for the given processing element. The apparatus also comprises at least one register accessible to firmware, wherein the apparatus is configured to control the selection of at least one energy control parameter in dependence on a value read from the at least one register.

The given processing element (wherein a processing element may alternatively be referred to as a processor, a processor core, a core or a processing unit, for example) could be any type of processing element—for example, the given processing unit could be a central processing unit (CPU), graphics processing unit (GPU), neural processing unit (NPU) or any other type of processor.

The precise definition of a higher-power processing task may vary dependent on the particular implementation of the present technique. For example, higher-power processing tasks may comprise so-called high energy events (HEEs) or high power events (HPEs)—note that the terms “high power event” (HPE), “high energy event” (TEE) and “higher-power processing task” are used interchangeably herein. HPEs may be a given type of processing task, and/or may comprise an identified subset of the processing tasks that processing circuitry of the processing element is capable of executing. An HPE may be defined as an instruction whose execution consumes more power than some threshold power consumption, with the threshold being dependent on (for example) the average power consumption for all instructions executed by processing circuitry of the given processing element (e.g. over a predetermined time), or the average power consumption for non-HPE instructions executed by the processing circuitry. In some examples, HPEs may be defined as processing tasks whose execution consumes more power than the threshold by a given margin (e.g. by 25%, 50%, 100%, etc.). In some examples, HPEs could be defined as, from among all events processed by a processing circuit, the top x % of energy consuming events. In some examples, HPEs could be defined as a subset of instruction types—for example, vector instructions and/or floating-point (FP) instructions may be classed as HPEs, since execution of these instructions typically consumes more power than is consumed when executing some other types of instructions.

The given processing element may throttle execution of HPEs by limiting the throughput of HPEs, and the throttling level may indicate the degree to which HPEs should be throttled—for example, each throttling level may define a proportion of received HPEs that can be issued to the processing circuitry within a certain time period. This reduces the throughput of HPEs (and may, as a result, reduce the overall throughput of instructions), hence reducing the power consumption of the apparatus. Accordingly, increasing the throttling level (e.g. reducing the execution rate of HPEs) can allow the voltage and/or clock frequency of the apparatus to remain at a higher level. On the flip side, reducing the voltage and/or the clock frequency can allow the HPE throttling level to be decreased. The throttling control circuitry and the power management circuitry work together to balance the throttling level and the voltage and/or clock frequency, to balance performance and power consumption.

The selection of the amount of HPE throttling and the voltage and/or clock frequency for the apparatus can be performed by firmware, and there can be advantages associated with allowing the firmware to influence this process. However, the inventors of the present technique realised an entirely firmware-controlled approach to selecting the amount of HPE throttling, the voltage and the clock frequency can also have some shortcomings. For example, an entirely firmware-controlled process may be slow to respond to changes in the reception rate of HPEs; this could be particularly problematic during execution of bursty HPE workloads. As a particular example, a firmware-controlled mechanism could be provided which uses threshold counters which can count every 128 CPU cycles, such that the response time for a firmware driven approach is typically in the 1-2 millisecond range. This means that a bursty HPE workload lasting 2,000,000 cycles (assuming CPU is clocked at 2 Ghz) could run throttled for its entire duration before the firmware has had the opportunity to reduce HPE throttling to match processor performance for that workload. This translates into poor performance for the entire workload.

The present technique provides an improved approach, which provides some of the advantages of involving firmware in the process, while also providing additional advantages that come with using hardware. In particular, the present technique provides an approach in which at least one firmware-accessible register is provided, and the apparatus is arranged to control the selection of at least one energy control parameter in dependence on a value read from the at least one register. This provides a mechanism for the firmware to influence the process (hence providing advantages such as the ability to tailor the process to particular operating conditions, etc.), without the process being entirely firmware-controlled. In particular, while the selection of the at least one energy control parameter is dependent on the value read from the firmware-accessible register (which may, therefore, be a value set or modified by the firmware), the present technique does not require the firmware itself to perform the process of selecting the throttling level to be applied, or the process of selecting the voltage and/or clock frequency for the apparatus. Instead, dedicated throttling control circuitry and power management circuitry are provided (e.g. in hardware) to perform these processes, with the provision of the at least one firmware-accessible register providing a mechanism by which the firmware can influence the process without the process being entirely firmware-implemented.

Using hardware to select the throttling level and the voltage and/or clock frequency is advantageous, because hardware can respond more rapidly to circumstances (such as a change in the reception rate of HPEs) than firmware typically can. This means that any delay between—for example—a change in the reception rate of HPEs being detected and the throttling level and/or voltage and/or clock frequency being adjusted can be reduced. This improves performance, by limiting the amount of time spent throttling HPEs more than necessary and/or the time spent operating at a lower voltage and/or frequency than is needed. Meanwhile, the value held in the at least one register can still be set by firmware, since this part of the process does not need to respond quickly to changes (e.g. because the value may be set in advance). In examples of the present technique, HPEs can be regulated and/or restricted by throttling the execution of HPEs received by a given processing element (e.g. limiting the execution rate at which the received HPEs are issued for execution)—this reduces the power consumption of the system, by reducing the number of HPEs executed within any given time period. In addition, the present technique allows the voltage and/or clock frequency of the system to be varied—lowering the voltage and/or clock frequency can also reduce the power consumption of the apparatus. This can help to prevent the power consumption of the apparatus exceeding some defined limit—for example, this could be a safe operating limit, above which the apparatus may be at risk of malfunction, or it could be a limit defined by the power supply or by thermal limits.

In the present technique, throttling control circuitry is provided to control (e.g. increase or decrease) the throttling level for HPEs (where the throttling level for a given processing element is a measure of the degree to which execution of HPEs by the given processing element is throttled), and power management circuitry is provided to control the voltage and/or clock frequency of the apparatus. This allows each of the throttling level and the voltage and/or clock frequency to be adjusted as the rate at which HPEs are received varies. This is helpful, because it allows the throttling level to be kept low (e.g. increasing the throughput of HPEs) and/or the voltage and/or clock frequency to be kept high where possible, to improve performance.

In some examples, the at least one energy control parameter comprises at least one of: the throttling level; the operating voltage; and the clock frequency.

Hence, in this example, the throttling control circuitry selects the throttling level in dependence on a value held in the at least one register and/or the power management circuitry selects the voltage and/or clock frequency in dependence on a value held in the at least one register. Note that the at least one energy control parameter can include one of the parameters listed above, or any combination of these parameters.

In some examples, the at least one register comprises a throttling control register to store a throttling control parameter, and the throttling control circuitry for the given processing element is configured to select the throttling level in dependence on the throttling control parameter read from the throttling control register.

Hence, in this example, the at least one energy control parameter comprises the throttling level, and the value read from the at least one register comprises the throttling control parameter. The firmware can thus write a throttling control parameter to the throttling control register to influence the selection, by the throttling control circuitry, of the throttling level. Note that there may be any number (one or more) of throttling control parameters, and any number (one or more) of throttling control registers.

In some examples, the at least one register comprises a power control register to store a power control parameter, and the power management circuitry is configured to select the operating voltage and/or clock frequency in dependence on the power control parameter read from the power control register.

Hence, in this example, the at least one energy control parameter comprises the operating voltage and/or the clock frequency, and the value read from the at least one register comprises the power control parameter. The firmware can thus write a power control parameter to the power control register to influence the selection, by the power management circuitry, of the voltage and/or clock frequency. Note that there may be any number of power control parameters, and any number of power control registers. Moreover, the at least one register may comprise both a throttling control register and a power control register.

In some examples, the apparatus comprises a plurality of processing elements including the given processing element, the plurality of processing elements sharing a common power supply, and the apparatus comprising throttling control circuitry associated with each processing element. In these examples, the at least one register comprises, for each throttling level selectable for the given processing element, a normalisation register, and the power management circuitry is configured to select the operating voltage and/or clock frequency for the plurality of processing elements in dependence on a normalised throttling level determined for each processing element, wherein the normalised throttling level for the given processing element comprises a value indicative of the selected throttling level for the given processing element normalised in dependence on a relative power impact of the selected throttling level on the given processing element compared with a power impact of the same throttling level on a different one of the plurality of processing elements, and wherein the normalised throttling level is dependent on a value held in the normalisation register for the throttling level selected for the given processing element.

Where the apparatus comprises multiple processing elements (such as in these examples), these could all be the same type (e.g. CPU, GPU, NPU, etc.) of processing element, or they could include two or more different types of processing element. In this example, the normalisation register may be an example of a power control register. In this particular example, multiple processing elements share a common power supply, so that they are all operate at the same operating voltage, and may also all be operating at the same clock frequency. As a particular example, the multiple processing elements may be connected to a shared power rail.

Sharing the same voltage supply (e.g. a shared power rail) across multiple cores is common. However, power management can be complicated when heterogeneous cores share the same voltage rail, so such systems may employ firmware algorithms to microarchitecturally normalize power levels for different HPE throttling levels across dissimilar cores, before making a decision for the shared voltage rail. However, these algorithms can become computationally intensive and slow the process down further. Moreover, such an approach might even lead to the microcontroller running the Power Management (PM) firmware to become undersized for its workload requirements; however, having a larger microcontroller that runs PM firmware is often not an option in power and/or area constrained devices.

This example of the present technique addresses this problem by normalising the selected HPE-throttling level, to scale the power impact of HPE throttling across cores with different microarchitectures. This normalised throttling level can be used by the power management circuitry in its decisions. This mechanism reduces the firmware load for adjusting HPE throttling levels, especially in the case where heterogeneous cores are powered by the same rail.

The value held in the normalisation register can be set and/or modified by the firmware, allowing the firmware to influence the normalisation of the selected throttling level, and as a result influence the selection of the voltage and/or clock frequency. Since the value does not need to be computed as part of the throttling control process or the power control process, it is acceptable to incur the latency associated with allowing firmware to compute the value (e.g. since the computation of the value in the normalisation register can be performed in advance, and hence need not affect the responsiveness of the apparatus to changes in the rate at which HPEs are received).

In some examples, the normalisation register for each throttling level selectable for the given processing element holds a normalisation factor associated with the selected throttling level, wherein the normalisation factor associated with the selected throttling level is indicative of the relative power impact of the selected throttling level on the given processing element compared with the power impact of the same throttling level on the different one of the plurality of processing elements. In these examples, the throttling control circuitry is configured to determine, for the given processing element, a throttling control value indicative of the selected throttling level, and to modify the throttling control value based on the associated normalisation factor to determine the normalised throttling level. Further, in these examples, the power management circuitry is configured to select the operating voltage and/or clock frequency for the plurality of processing elements in dependence on the normalised throttling level determined for each processing element.

The throttling control value for each throttling level may be held in a throttling control register, which may itself be included in the at least one register described above—hence, in at least some examples, the throttling control value for each normalisation level may be set by firmware. The throttling control circuitry may modify the throttling control value in any of a number of ways, but in some examples the throttling control circuitry may comprise multiplication circuitry to multiply the throttling control value by the associated normalisation factor.

Note that, while the normalisation register in this example holds a normalisation factor, in other examples it may instead hold the normalised throttling level itself.

In some examples, the apparatus comprises combination circuitry to generate a power selection value by combining the normalised throttling levels for each of the plurality of processing elements, and the power management circuitry is configured to perform a lookup, based on the power selection value, in a lookup table to determine the operating voltage and/or clock frequency for the plurality of processing elements.

In a particular example, the combining circuitry could comprise an adder to add together the normalised throttling levels. The lookup table may be stored in main memory, with portions of the table optionally being cached in caches between the main memory and the power management circuitry. Alternatively, the lookup table may be stored in local storage circuitry (e.g. a cache or a set of registers) accessible to the power management circuitry.

In some examples, the throttling control circuitry is configured to select the throttling level for the given processing element from amongst a plurality of different throttling levels, and the at least one register comprises, for each throttling level selectable by the throttling control circuitry for the given processing element, at least one threshold register to hold a threshold value indicative of a condition for selecting that throttling level.

In this example, the at least one energy control parameter includes the throttling level. Hence, the firmware may be permitted to write to the threshold register in order to influence the selection of the throttling level—for example, by adjusting the threshold for selecting each throttling level. The value in the threshold register can be set in advance, and hence does not need to be computed as part of the throttling control process or the power control process. As a result, it is acceptable to incur the latency associated with allowing firmware to compute this value, since the computation of the value in the threshold register need not affect the responsiveness of the apparatus to changes in the rate at which HPEs are received.

In some examples, the throttling control circuitry comprises comparison circuitry to perform a plurality of comparisons to compare, for the given processing element, a count value received from the given processing element with the threshold value held in each threshold register associated with the given processing element, wherein the count value is indicative of a reception rate at which the higher-power processing tasks are received by the given processing element. In these examples, the throttling control circuitry is configured to select the throttling level for the given processing element in dependence on the plurality of comparisons.

In this way, the throttling level—and, therefore, the voltage and/or clock frequency—can be controlled dynamically, in dependence on the rate at which HPEs are being received at each processing element. In a particular example, each processing element may comprise one or more counters to track the rate at which HPEs are encountered by the processing element. The counters may include a single counter to count the number of HPEs (or the number of HPEs in a given period). The counters may also/instead include a separate counter for each throttling level selectable for that processing element, to count a number of HPEs that would have been executed in a predetermined time if the processing element had been operating using the corresponding throttling level. However, it will be appreciated that the exact format of the counter or counters is not particularly limited, and any counter circuitry capable of tracking the reception rate of HPEs may be used in this example.

In some examples, the at least one threshold register comprises, for a given throttling level selectable by the throttling control circuitry, a throttle-up threshold register holding a threshold value indicative of a throttle-up condition and a throttle-down threshold register holding a threshold value indicative of a throttle-down condition. In these examples, the comparison circuitry is configured to perform the plurality of comparisons to compare the count value received from the given processor core with the threshold value held in each of the two or more threshold registers associated with each throttling level. Further, in these examples, the throttling control circuitry is responsive to the comparison circuitry determining that the throttle-up condition has been met to select, for the given processing element, the given throttling level or a higher throttling level, wherein the execution rate at which higher-power processing tasks received by the given processing element are to be issued to processing circuitry of the given processing element is lower at the higher throttling level. Further, in these examples, the throttling control circuitry is responsive to the comparison circuitry determining that the throttle-down condition has been met to select, for the given processing element, a lower throttling level than the given throttling level, wherein the execution rate at which higher-power processing tasks received by the given processing element are to be issued to processing circuitry of the given processing element is higher at the lower throttling level.

In this way, it is possible to define a throttle-up condition and a throttle-down condition such that they differ from one another. This makes it possible to define a hysteresis band to prevent down-shifts or up-shifts in the throttling level being made too early (e.g. the hysteresis band can dampen the effect of a fluctuating HPE reception rate). Note that it is not necessary for both a throttle-up register and a throttle-down register to be provided for all throttling levels. For example, for the lowest throttling level for a given processing element, there may be a throttle-up register but no throttle-down register. Similarly, for the highest throttling level for a given processing element, there may be a throttle-down register but no throttle-up register.

In some examples, the throttling control circuitry is responsive to a trigger condition being met to select the throttling level for the given processing element.

For example, the trigger could be time-based (as discussed in an example below), or it could be based on some high activity factor in the given processing element, current draw change patterns, or any other factor.

In some examples, the throttling control circuitry is configured to determine that the trigger condition has been met after a predetermined period of time has elapsed since the trigger condition was last determined to have been met.

Hence, the apparatus of the present technique may operate periodically—for example, it may periodically assess the HPE reception rate on each processing element to determine whether to adjust the throttling level, voltage and/or clock frequency.

In some examples, the apparatus comprises a sampling-cycles register to store a value indicative of a number of processor cycles corresponding to the predetermined period of time, wherein the throttling control circuitry is configured to determine, in dependence on the value stored in the sampling-cycles register, whether the trigger condition has been met Hence, the sampling-cycles register may define how frequently the apparatus operates.

The sampling-cycles register may, in particular examples, be accessible to firmware, and hence may provide another mechanism by which the firmware can influence the operation of the apparatus, without the process needing to be entirely firmware-controlled.

As explained above, higher-power processing tasks may be defined in any of a number of different ways.

In some examples, the higher-power processing tasks comprise an identified subset of processing tasks executable by the processing circuitry of the given processing element.

In some examples, the higher-power processing tasks comprise processing tasks whose execution by the processing circuitry is expected to consume more a threshold amount of power.

In some examples, the higher-power processing tasks comprise instructions of a given type.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in, for example, Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc.

An integrated circuit fabricated using the computer-readable code may comprise components such as one or more of a central processing unit, graphics processing unit, neural processing unit, digital signal processor or other components that individually or collectively embody the concept.

Particular embodiments will now be described with reference to the figures.

FIG. 1 schematically illustrates a data processing apparatus 100 in accordance with some embodiments. The data processing apparatus 100 receives an event stream 105 which could take the form of a stream of instructions. The stream of instructions is fetched from, for instance, an instruction cache or main memory by a fetcher 110. In this example, the fetcher 110 divides the instructions into two portions based on their type—HPE or non-HPE. There are a number of ways in which such categorisation can take place, but in these embodiments, vector instructions are considered to be HPEs while scalar instructions are considered to be non-HPEs. The non-HPE instructions 130 are passed, via a pipeline, to processing circuitry 135 where the instructions are executed. The HPE instructions 115 are passed to both a throttle 125 and a counter 120.

In large data processing apparatuses, the range of dynamic power across applications can be very wide, and the potential current drawn during execution of so-called HPEs (e.g. instructions whose execution is associated with a higher than average power consumption) can exceed the voltage rail provisioned limits. A mechanism may, therefore, be provided to throttle HPEs, to prevent the current limits being exceeded.

The throttle controls the rate at which HPE instructions 115 are passed on to the processing circuitry via the pipeline 135. This makes it possible to slow down the rate at which HPE instructions 115 are processed, or to extend their execution across a number of processor cycles. The counter 120 is an example of tracking circuitry for tracking the reception rate at which HPEs are received at the counter, and in this example counts the number of HPE instructions 115 that are received within a micro-interval (a plurality of ticks of a clock signal provided to the data processing apparatus 100). This updated count 120 is then compared via a number of comparators 155, 160, 165 to thresholds Z₁, Z₂, Z₃.

Each of the comparisons 155, 160, 165 compares the current count value 120 to one of the thresholds Z₁, Z₂, Z₃ and increases a corresponding counter value 170, 175, 180 if the comparison indicates that the current count is higher. The counters 170, 175, 180 are therefore indicative of the number of micro-intervals for which each of the thresholds Z₁, Z₂, Z₃ is exceeded in the current macro-interval. For example, each of the thresholds Z₁, Z₂, Z₃ could correspond to a throttling level selectable for the apparatus, and may indicate a number of HPEs which would have been held back by the throttle 125 if it were operating at the corresponding throttling level. Note, however, that this is just one example of how the data processing apparatus may count HPE instructions—any other mechanism for tracking the reception rate at which HPE events are received can be used instead.

One way of managing the throttling of HPEs could be by engaging a firmware-controlled power management mechanism. However, the inventors of the present technique realised that a firmware-controlled mechanism like this can have several shortcomings. For example:
1. Poor responsiveness to bursty HPE workloads: While the counters described above may be capable of counting every 128 CPU cycles, the response time for a firmware-driven approach is typically in the 1-2 millisecond range. This means that a bursty workload lasting 2,000,000 cycles (assuming that the processing elements are clocked at 2 Ghz) could run throttled for its entire duration before the firmware has had the opportunity to reduce HPE throttling to match the performance for that workload. This can translate into poor performance for the entire workload.
2. Sharing the same voltage rail across multiple processing elements is common. When heterogeneous cores share the same voltage rail, firmware algorithms may be used to microarchitecturally normalize power levels for different HPE throttling levels across dissimilar cores, before making a safe performance decision for the shared voltage rail. These algorithms become computationally intensive and slow the process down further. It might even lead to the microcontroller running the Power Management (PM) firmware to become undersized for its workload requirements. Having a larger microcontroller that runs PM firmware is often not an option in power and area constrained devices.

To address these issues, the data processing apparatus 100 comprises an HPE throttling engine 140, provided in hardware. The HPE throttling engine is a hardware element which controls power management for the data processing apparatus. In particular, the HPE throttling engine 140 controls the voltage supply for the data processing apparatus via a voltage regulator 145, and controls the clock frequency via a frequency regulator 150. In addition, the HPE throttling engine 140 controls the throttle 125 and can thereby limit the extent to which HPE instructions 115 are executed.

In this way, based on the number of HPE instructions that are encountered, the HPE throttling engine 140 is able to vary the voltage, frequency, and throttling of the HPE instructions in order to achieve an overall high throughput of instruction execution while limiting power consumption of the data processing apparatus 100. For example, increasing the throttling level (the degree to which HPE instructions are throttled) can reduce power consumption by limiting the throughput of HPE instructions (execution of which, as mentioned above, typically consumes more power than execution of other instructions). However, increasing the throttling level can have a negative impact on the performance of the data processing apparatus, due to the decreased throughput of HPE instructions—this may be particularly noticeable during execution of workloads with a relatively high proportion of HPE instructions. Another way to reduce power consumption is to reduce the voltage supplied to the data processing apparatus and/or to reduce the clock frequency. However, this can negatively impact performance.

Generally, it may be preferable for the throttling level to be kept low (e.g. to allow as many HPE instructions to be executed as possible). This may mean that, when the HPE reception rate (the rate at which HPE instructions are fetched by the fetcher 110) is high, it is generally preferable to reduce power consumption by decreasing the voltage and/or frequency, rather than by increasing the throttling level. However, the HPE throttling engine 140 can typically control the throttle 125 to adjust the throttle rate more quickly than it can cause the voltage and clock frequency to be adjusted. This may mean that, for a period of time (e.g. a transition period) between the reception rate of HPEs increasing and the voltage and/or clock frequency being decreased, it becomes necessary to increase the HPE throttling level in order to avoid exceeding some power consumption limit (e.g. this could be a limit defined by safety constraints).

In practice, the throttling rate may be kept at a relatively high level by default, with the frequency and voltage being kept high as well. This is to reduce the likelihood of any delays in adjusting the throttling level/frequency/voltage moving the system into an unsafe mode.

In any case, it would be advantageous to limit the length of this transition period, to improve performance. It would also be advantageous to react more quickly to a decrease in the HPE reception rate, since a longer transition time in this case can mean that the data processing core operates at a lower frequency/voltage for longer than is necessary. Hence, it would be advantageous to improve the responsiveness of the HPE throttling engine to changes in the HPE reception rate.

As noted above, the HPE throttling engine is provided in hardware; this allows the HPE throttling engine to respond more quickly to changes in the HPE reception rate than would be the case in a purely firmware based approach. This improves the performance of the data processing apparatus as discussed above.

Note that, while the HPE throttling engine is a hardware component, its operation can be influenced by firmware executing on, for example, a microcontroller (or the processing circuitry 135). In particular, firmware can write to one or more registers accessible to the HPE throttling engine, and the HPE throttling engine operates in dependence on the values written to these registers.

FIG. 2 illustrates another example of a data processing apparatus 200, showing an example of the circuitry of an HPE throttling engine. In particular, FIG. 2 shows an example of circuitry which allows the HPE throttling engine to be implemented in hardware.

The data processing apparatus 200 comprises three processing elements 205 (also referred to as processor cores), each connected to a common power supply 210. The processing elements 205 (also referred to as processor cores or processing units) could include one or more central processing units (CPUs), one or more graphics processing units (GPUs), one or more neural processing units (NPUs), or any other type of processing unit. Because they are provided with a common power supply 210, the processing elements 205 typically operate at the same voltage, and may also operate at the same clock frequency. Note that the clock frequency is related to the voltage. For a given voltage, a maximum clock rate can be selected, although it is typically possible to safely run at a lower than clock rate than the maximum clock rate (although it may be inefficient to do so). Note that, while the data processing apparatus 200 is shown in FIG. 2 as comprising three processing elements 205, this is just one example or the number of processing elements which may be provided. In other examples, more than three or fewer than three processing elements could be provided. Moreover, while the present technique provides particular benefits in systems comprising multiple cores sharing a voltage supply, it is also possible for the present technique to be implemented in an apparatus comprising a single processor core, or multiple processor cores which do not share a voltage rail.

As shown in FIG. 2, the HPE throttling engine 140 comprises throttling control circuitry 215 associated with each processing element 205—in this example, three instances of the throttling control circuitry 215 are provided, with one instance of the throttling control circuitry 215 associated with each of the processor cores 205. The throttling control circuitry for a given processing element 205 is responsible for selecting the throttling level for that processing element and informing the power management circuitry 220 of the selected throttling level. The throttling control circuitry 215 is an example of throttling control circuitry associated with a given processing element, the throttling control circuitry being configured to perform a throttling-level selection process to select a throttling level indicative of an execution rate at which higher-power processing tasks received by the given processing element are to be issued to processing circuitry of the given processing element. Note that, in other examples, a single instance of the throttling control circuitry may be responsible for selecting the throttling level for multiple processing elements.

The power management circuitry 220 receives information (e.g. an indication of the selected throttling level for each processor core 205) from each instance of the throttling control circuitry 215, and uses this information to select a voltage and clock frequency for multiple processing elements 205 connected to the common power supply 210. Note that, when decreasing the throttling level, the frequency and/or voltage may need to be reduced before the throttling level is reduced, in order to remain within safe operating limits. Conversely, when increasing the throttling level, it can be safer to adjust the throttling level before adjusting the frequency and/or voltage. The power management circuitry 220 is an example of power management circuitry to perform a power control process to select an operating voltage and/or clock frequency to be used by the given processing element, wherein the power management circuitry is configured to select the operating voltage and/or clock frequency in dependence on the throttling level selected for the given processing element.

By providing dedicated circuitry for controlling the throttling level for each core and the voltage and clock frequency for all of the cores, the HPE throttling engine 140 provides the above-described advantages associated with a hardware-implementation. In particular, providing a mechanism for implementing the HPE engine in hardware allows the performance of the system as a whole to be improved.

The HPE throttling engine also includes one or more firmware-accessible registers 225 (alternatively, these could be software-accessible registers), and operates (e.g. selects the throttling levels and/or voltage and/or clock frequency) in dependence on the data stored in those registers. In particular, the registers 225 are accessible to the firmware (e.g. this may be supervisory software that comes pre-installed on a processing element) executing on a separate microcontroller or on processing circuitry of one or more of the processing elements 205. This allows the firmware to influence the selection of throttling levels and/or the selection of the voltage and/or clock frequency, without the entire process needing to be performed by the firmware (and hence without incurring the performance cost associated with a purely firmware-based implementation). The software-accessible registers 225 are an example of at least one register accessible to firmware, wherein the apparatus is configured to control the selection of at least one energy control parameter in dependence on a value read from the at least one register.

FIG. 3 shows an example of the circuitry in an HPE throttling engine 140 in more detail. In this example, two instances of the throttling control circuitry 215 are shown, and it is assumed that three throttling levels are defined for each processing element; however, it will be appreciated that there may be more or fewer instances of the throttling control circuitry, depending on the number of processing elements connected to the common power supply.

Moreover, there may be any number of throttling levels defined for a given processing element, and the number of throttling levels defined need not necessarily be the same for all of the processing elements.

The apparatus shown in FIG. 3 provides the following:
1. A dedicated HPE throttling engine 140, provided in hardware. This engine determines and adjusts the throttling level of HPEs in each processing element very quickly (e.g. this could be with sub-millisecond latency) to respond to rapidly changing (bursty) workloads. This engine runs periodically, and its control parameters are configured by the firmware, allowing the firmware to influence the process without incurring the performance cost associated with a full firmware-controlled process.
2. A per-HPE-throttling level dynamic normalization factor, which scales the power impact of HPE throttling across different processing elements (for example, the power impact may differ across different types of processing element (e.g. the power impact may differ for a CPU versus a GPU or NPU), and/or across processing elements with different arrangements (e.g. different architectures and/or different microarchitectures). This factor can be used by the HPE throttling engine 140 in its decisions. This mechanism reduces the firmware load for adjusting HPE throttling levels, especially in the case where heterogeneous cores are powered by the same rail.

The HPE throttling engine 140 comprises a number of registers which control its operation—these are examples of the registers 225 shown in FIG. 2. The registers include:
“Start/Stop Engine” registers 300: These registers, configured by supervisory firmware, start and stop the HPE throttling engine.
“Sampling cycles” register 305: This register, configured by supervisory firmware, sets the rate at which the HPE throttling engine rescans the HPE throttling threshold count registers.
“Threshold-down” registers 310 and “Threshold-up” registers 315: These registers (also referred to as “throttle-up” and “throttle-down” registers respectively) contain a count value corresponding to a number of throttling events. They are configured by the supervisory firmware and used to decide when to change the configured HPE throttling level. The throttling engine reads the HPE throttling threshold counters 170, 175, 180 every sampling period and compares them to the threshold_up/down registers. If the count falls below threshold_down, it indicates to the HPE throttling engine that HPEs in the workload have decreased. And hence the threshold above which HPE throttling would happen (throttling threshold) can be decreased as well. In this case, the throttling level is increased. If the throttling threshold count is greater than threshold_up, it indicates to the HPE throttling engine that HPEs in the workload have increased. Hence, the threshold above which HPE throttling would happen (throttling threshold) should be increased as well. In this case, the throttling level may be decreased, to improve performance. These registers allow the supervisory firmware to indicate system bias towards HPE throttling. Having separate Threshold-Up and Threshold-Down registers allows to implement a hysteresis band to prevent down-shifts or up-shifts in the throttling threshold too early.
“Threshold value” registers 320: An integer value assigned to a throttling level. This may be representative of the relative power impact of operating at a particular throttling level—e.g. the lower the throttling level, the higher this value.
“Normalization” registers 325: Integer values which represent the relative power impact of each throttling level, compared to the same throttling level on another processing element with a different microarchitecture. This register is used to normalize the power impact due to microarchitectural differences when cores of different microarchitectures are connected to the same power rail and choose the same throttling level. The way in which the normalization values are defined is not particularly limited but, in a particular example, if the power impact at throttling level 1 for a first processor core is 3 W (3 Watts) and for a second processor core is 2 W, then the normalization factor for throttling level 1 for the second processor core can be 2 and for the first processor core can be 3.
“Lookup” register 330: this is populated by the firmware with the start address of a lookup table 335. The lookup table 335 maps the combination of throttling threshold values (e.g. the normalized sum of all cores sharing the same rail, as will be discussed in more detail below) and the respective maximum DVFS gear (a DVFS gear being indicative of a voltage level and a clock frequency) which could be safely selected with that combination. An example using 4 cores with 3 throttling thresholds is given below (for simplicity we assume Threshold N power value=N):

Lookup = { /* {Power Value, Freq (Hz)} */
{4, 3000000000}, /* Throttling level 3 (=1), selected for all 4 cores */
{8, 2500000000}, /* Throttling level 2 (=2), selected for all 4 cores */
{12, 180000000}, /* Throttling level 1 (=3), selected for all 4 cores */
}

FIG. 4 illustrates an example of the lookup table 335. In this particular example, the lookup table has an entry for each possible result of the normalized sum mentioned above. For each sum, a voltage in volts and a frequency in gigahertz are defined. Note that the table could instead record a DVFS gear for each addition result, with the DVFS gear being indicative of the voltage and clock frequency.

The overall power consumption by the data processing apparatus 100, 200 is a function of each of the throttling levels for each of the cores, the voltage, and the frequency. In particular, as a voltage and frequency drop, there is a non-linear decrease in power consumption (a squared relationship). For instance, when the voltage drops in half, the power consumption drops to approximately a quarter.

### Example Mechanism

Returning to FIG. 3, the following example of a mechanism of operation of the HPE throttling engine is provided.

The throttling engine 140 rescans the throttling threshold count registers after every configured “Sampling cycles”. (The throttling threshold count registers indicate how many HPE events were above the threshold for each implemented throttling level, even if the level was not enforced). Each throttling level is denoted by an integer (populated in the corresponding throttling threshold register 320) which indicates the approximate power impact due to the throttling threshold selection. Hence, the higher the throttling level, the more throttling is being applied (for example, if 60% of HPEs are throttled, this means that the “throttling level” is higher than if no HPEs are being throttled). Hence, the higher the throttling level, the higher the voltage and clock frequency can safely be set to.

The throttling engine compares the throttling threshold count registers against the supervisory firmware configured threshold-up/down registers. If the value specified by threshold-down register is breached, then the configured throttling level is increased (meaning more throttling of HPE events, as explained above), and frequency/voltage is increased to improve performance since the workload is light on HPE events. If the value specified by the threshold-up register is breached, then the configured throttling level is decreased (meaning less throttling of HPE events), and core frequency/voltage is reduced to limit maximum power draw since the core is running HPE intensive workloads. This comparison is done across all implemented throttling levels on the core to determine the most suitable throttling threshold to be set.

The throttling value is now multiplied with the normalization factor 325 to account for throttling level specific microarchitectural differences in power among different cores which share the same voltage rail.

The values obtained from this multiplication, from all processing elements (PEs) which share the same rail, are now added together, and used to lookup the lookup table 335 to determine the maximum safe operating point. Any value which falls in between two power value entries in the table is run at the lowest of the two DVFS OPP (DVFS operating point—the selected voltage and frequency).

The selected DVFS OPP is now fed to the power control circuitry (DVFS module) 220, which adjusts the voltage and clocks for the PEs as required. The power control circuitry 220 may also take into account additional factors, such as requests from supervisory firmware, when selecting the voltage and clock frequency.

The DVFS module signals completion of the newly set target OPP to the HPE throttling engine, which can use this information to now safely set the throttling level selected for each PE (note that, when increasing the throttling level, the throttling level for each PE is set before adjusting the OPP).

If the supervisory firmware requests a performance level which exceeds the safe OPP set by the throttling engine, the DVFS module caps such a request to always maintain a safe OPP.

### Methods of Operation

Example methods are shown in FIGS. 5 and 6.

In FIG. 5, count values are received from each of a plurality of processor cores in steps 500, 505 and 510. In steps 515, 520 and 525, a throttling level for each of the processor cores is chosen, in dependence on the received count values. An operating voltage and clock frequency are then selected in step 530, depending on the selected throttling levels.

FIG. 6 shows a more detailed example of a method according to the present technique. As shown in FIG. 6, one or more count values are received from a given processor core (processor core 0) in step 500. These count values are compared, in step 600, with one or more thresholds defined for each throttling level selectable for the given processor core. In step 515, a throttling level is selected on the basis of the comparisons, and in step 605, a threshold value corresponding to the selected throttling level is multiplied by an associated normalization value.

A similar process to that shown in steps 500, 600, 515 and 605 is also performed for each other processor core connected to the same common power supply (steps 610 and 615).

In step 620, the normalized value determined for each processor core is received, and in step 625 these values are added together. The result of the sum is then looked up in a lookup table (step 630) to determine a voltage and frequency for all of the process cores. In step 640, the throttling level for each core is set to the level selected in step 515.

Accordingly, the methods shown in FIGS. 5 and 6 are each examples of a method comprising:
performing a throttling-level selection process to select a throttling level for a given processing element, the throttling level for the given processing element being indicative of an execution rate at which higher-power processing tasks received by the given processing element are to be issued to processing circuitry of the given processing element;
performing a power control process to select an operating voltage and/or clock frequency to be used by the given processing element, wherein the operating voltage and/or clock frequency is selected in dependence on the throttling level selected for the given processing element; and
controlling the selection of at least one energy control parameter in dependence on a value read from at least one register, the at least one register being accessible to firmware.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Further, the words “comprising at least one of . . . ” in the present application are used to mean that any one of the following options or any combination of the following options is included. For example, “at least one of: A; B and C” is intended to mean A or B or C or any combination of A, B and C (e.g. A and B or A and C or B and C).

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
throttling control circuitry associated with a given processing element, the throttling control circuitry being configured to perform a throttling-level selection process to select a throttling level indicative of an execution rate at which higher-power processing tasks received by the given processing element are to be issued to processing circuitry of the given processing element;
power management circuitry to perform a power control process to select an operating voltage and/or clock frequency to be used by the given processing element, wherein the power management circuitry is configured to select the operating voltage and/or clock frequency in dependence on the throttling level selected for the given processing element; and
at least one register accessible to firmware,
wherein the apparatus is configured to control the selection of at least one energy control parameter in dependence on a value read from the at least one register.

2. The apparatus of claim 1, wherein
the at least one energy control parameter comprises at least one of:
the throttling level;
the operating voltage; and
the clock frequency.

3. The apparatus of claim 1, wherein:
the at least one register comprises a throttling control register to store a throttling control parameter; and
the throttling control circuitry for the given processing element is configured to select the throttling level in dependence on the throttling control parameter read from the throttling control register.

4. The apparatus of claim 1, wherein:
the at least one register comprises a power control register to store a power control parameter; and
the power management circuitry is configured to select the operating voltage and/or clock frequency in dependence on the power control parameter read from the power control register.

5. The apparatus of claim 1, comprising:
a plurality of processing elements including the given processing element, the plurality of processing elements sharing a common power supply, and the apparatus comprising throttling control circuitry associated with each processing element;
the at least one register comprises, for each throttling level selectable for the given processing element, a normalisation register; and
the power management circuitry is configured to select the operating voltage and/or clock frequency for the plurality of processing elements in dependence on a normalised throttling level determined for each processing element, wherein the normalised throttling level for the given processing element comprises a value indicative of the selected throttling level for the given processing element normalised in dependence on a relative power impact of the selected throttling level on the given processing element compared with a power impact of the same throttling level on a different one of the plurality of processing elements,
wherein the normalised throttling level is dependent on a value held in the normalisation register for the throttling level selected for the given processing element.

6. The apparatus of claim 5, wherein:
the normalisation register for each throttling level selectable for the given processing element holds a normalisation factor associated with the selected throttling level, wherein the normalisation factor associated with the selected throttling level is indicative of the relative power impact of the selected throttling level on the given processing element compared with the power impact of the same throttling level on the different one of the plurality of processing elements;
the throttling control circuitry is configured to determine, for the given processing element, a throttling control value indicative of the selected throttling level, and to modify the throttling control value based on the associated normalisation factor to determine the normalised throttling level; and
the power management circuitry is configured to select the operating voltage and/or clock frequency for the plurality of processing elements in dependence on the normalised throttling level determined for each processing element.

7. The apparatus of claim 5, comprising:
combination circuitry to generate a power selection value by combining the normalised throttling levels for each of the plurality of processing elements,
wherein the power management circuitry is configured to perform a lookup, based on the power selection value, in a lookup table to determine the operating voltage and/or clock frequency for the plurality of processing elements.

8. The apparatus of claim 1, wherein:
the throttling control circuitry is configured to select the throttling level for the given processing element from amongst a plurality of different throttling levels; and
the at least one register comprises, for each throttling level selectable by the throttling control circuitry for the given processing element, at least one threshold register to hold a threshold value indicative of a condition for selecting that throttling level.

9. The apparatus of claim 8, wherein:
the throttling control circuitry comprises comparison circuitry to perform a plurality of comparisons to compare, for the given processing element, a count value received from the given processing element with the threshold value held in each threshold register associated with the given processing element, wherein the count value is indicative of a reception rate at which the higher-power processing tasks are received by the given processing element; and
the throttling control circuitry is configured to select the throttling level for the given processing element in dependence on the plurality of comparisons.

10. The apparatus of claim 9, wherein:
the at least one threshold register comprises, for a given throttling level selectable by the throttling control circuitry, a throttle-up threshold register holding a threshold value indicative of a throttle-up condition and/or a throttle-down threshold register holding a threshold value indicative of a throttle-down condition;
the comparison circuitry is configured to perform the plurality of comparisons to compare the count value received from the given processor core with the threshold value held in each of the at least one threshold register associated with each throttling level;
the throttling control circuitry is responsive to the comparison circuitry determining that the throttle-up condition has been met to select, for the given processing element, the given throttling level or a higher throttling level, wherein the execution rate at which higher-power processing tasks received by the given processing element are to be issued to processing circuitry of the given processing element is lower at the higher throttling level; and
the throttling control circuitry is responsive to the comparison circuitry determining that the throttle-down condition has been met to select, for the given processing element, a lower throttling level than the given throttling level, wherein the execution rate at which higher-power processing tasks received by the given processing element are to be issued to processing circuitry of the given processing element is higher at the lower throttling level.

11. The apparatus of claim 1, wherein:
the throttling control circuitry is responsive to a trigger condition being met to select the throttling level for the given processing element.

12. The apparatus of claim 11, wherein
the throttling control circuitry is configured to determine that the trigger condition has been met after a predetermined period of time has elapsed since the trigger condition was last determined to have been met.

13. The apparatus of claim 12, comprising
a sampling-cycles register to store a value indicative of a number of processor cycles corresponding to the predetermined period of time,
wherein the throttling control circuitry is configured to determine, in dependence on the value stored in the sampling-cycles register, whether the trigger condition has been met.

14. The apparatus of claim 1, wherein
the higher-power processing tasks comprise an identified subset of processing tasks executable by the processing circuitry of the given processing element.

15. The apparatus of claim 1, wherein
the higher-power processing tasks comprise processing tasks whose execution by the processing circuitry is expected to consume more a threshold amount of power.

16. The apparatus of claim 1, wherein
the higher-power processing tasks comprise instructions of a given type.

17. A method comprising:
performing a throttling-level selection process to select a throttling level for a given processing element, the throttling level for the given processing element being indicative of an execution rate at which higher-power processing tasks received by the given processing element are to be issued to processing circuitry of the given processing element;
performing a power control process to select an operating voltage and/or clock frequency to be used by the given processing element, wherein the operating voltage and/or clock frequency is selected in dependence on the throttling level selected for the given processing element; and
controlling the selection of at least one energy control parameter in dependence on a value read from at least one register, the at least one register being accessible to firmware.

18. A computer program comprising computer-readable code which, when executed on a computer, causes the computer to fabricate an apparatus comprising:
throttling control circuitry associated with a given processing element, the throttling control circuitry being configured to perform a throttling-level selection process to select a throttling level indicative of an execution rate at which higher-power processing tasks received by the given processing element are to be issued to processing circuitry of the given processing element;
power management circuitry to perform a power control process to select an operating voltage and/or clock frequency to be used by the given processing element, wherein the power management circuitry is configured to select the operating voltage and/or clock frequency in dependence on the throttling level selected for the given processing element; and
at least one register accessible to firmware,
wherein the apparatus is configured to control the selection of at least one energy control parameter in dependence on a value read from the at least one register.

19. A computer-readable medium to store the computer program of claim 18.
